(19) United States
(12) Patent Application Publication
(10) Pub. No.: US 2009/0320532 A1
(43) Pub. Date: Dec. 31, 2009

(54) ANTI-THEFT DEVICE

(76) Inventor: Ferruccio Bonato, Peschiera Del Garda (IT)

Correspondence Address: Modiano & Associati, Via Meravigli 16, Milan, 20123, IT

(21) Appl. No.: 12/312,099

(22) PCT Filed: Oct. 29, 2007
(86) PCT No.: PCT/EP2007/009361

§ 371 Date: Apr. 24, 2009

(30) Foreign Application Priority Data
Nov. 7, 2006 (IT) VR2006A000168

(51) Int. Cl. E05B 65/00

(52) U.S. Cl. 70/57.1

(57) ABSTRACT

An anti-theft device comprising an electrically conducting flexible cable which is connected, at one end, to elements for detachable engagement with an item to be retained and is provided with elements for detecting the engagement of said detachable engagement elements for detachable engagement with the item to be retained, and a supporting base which can be associated with a control unit which is designed to act in response to the detection, by the detection elements, of the engagement/disengagement of the detachable engagement elements for detachable engagement with the item to be retained, the device further comprising elements for detachable connection between the flexible cable and the supporting base.

The present invention relates to an anti-theft device suitable particularly for use in association with displays of goods for sale, for example technological accessories, such as mobile telephones and MP3 players, but also for eyeglasses, jewels, watches, et cetera.

### BACKGROUND OF THE INVENTION

As is known, it would be desirable to be able to allow customers of a shopping center or of a shop to pick up, handle and possibly try goods before purchase, but this generally contrasts with the need to ensure that the goods are not stolen and taken away without paying for them.

Anti-theft tags have already been proposed which however are only suitable for interior spaces, where it is possible to provide adequate control by assigned personnel, but cannot give any assurance against theft in open-air exhibitions, for example on forecourts, or in commercial spaces provided inside the halls of shopping centers or malls.

Moreover, anti-theft tags are constituted in many cases by devices which must break in order to release the item on sale, and this forces the retailer to purchase new devices continuously, with an increase in sale cost.

In order to solve these problems, European patent no. EP 1 383 979 B1 by the same Applicant devised an anti-theft device constituted substantially by a spool made of electrically insulating material, which is mounted so that it can rotate on a support, and by a cable, which can be wound onto the spool and unwound from it and has a free end which can be anchored detachably to the item to be retained thanks to the presence of means for detachable engagement.

The spool is associated with an elastic loading spring to keep the cable under tension and rewind it automatically.

The detachable engagement means are adapted to open and/or close the electrical contact, while a control unit is designed to generate control signals for an alarm device if the electrical circuit is opened due to a theft attempt: currently, the alarm device is located in the vicinity of the spool and therefore the sound originates from the location where the attempted theft is occurring.

In the preferred embodiment of the device briefly described above, the spool is supported by the central portion of a supporting shaft and the cable supported by said spool is formed by two conducting wires which are sheathed and enclosed advantageously in an insulating sheath.

In order to supply power to the electrical circuit, which can be opened at the detachable connection means, the ends of the two conducting wires are connected to respective sliding shoes or springs, which are designed to abut against respective plates located proximate to the sides of the spool.

In turn, the plates are connected to the control unit, which is constituted for example by a controller.

Although the device described above has been particularly successful on a commercial level, the need has been observed to provide a device which ensures higher modularity, so as to allow its use also in association with means for detachable connection and/or with controllers which are already commercially available and installed in shops or shopping centers.

All currently commercially available types of anti-theft devices in fact provide monolithically, i.e., in a single body, the so-called electronic part, which manages the connection to the mains and the alarm procedures and is fixed generally to column-style displays or display counters, and the so-called mechanical part, which is constituted by the takeup spool and by the means for detachable connection to the item to be retained.

This aspect suffers the drawback of having to provide, in case of malfunction of the means for detachable connection and/or in case of breakage of the sheathed cable, the complete removal of the block which comprises both the electronic part and the mechanical part; a removal which the personnel is not always able to perform.

After its removal, the block must be taken to be repaired, disassembled and fixed by an assigned technician and then returned to the shop and reinstalled, again by an assigned worker.

It is evident that all these operations cause substantial management problems, especially in shops which have a large number of displays.

### SUMMARY OF THE INVENTION

The aim of the present invention is to provide an anti-theft device which allows to eliminate or at least reduce drastically the drawbacks noted above.

Within this aim, an object of the present invention is to provide an anti-theft device which can be used to retain any type of item and to manage rapidly and inexpensively any breakages and/or replacements that might be necessary.

Another object of the invention is to devise an anti-theft device which has a competitive production cost, so that its use is advantageous also from an economical standpoint.

This aim and these and other objects, which will become better apparent hereinafter, are achieved by an anti-theft device which comprises an electrically conducting flexible cable which is connected, at one end, to means for detachable engagement with an item to be retained and is provided with means for detecting the engagement of said means for detachable engagement with the item to be retained, and a supporting base which can be associated with a control unit which is designed to act in response to the detection, by said detection means, of the engagement/disengagement of said means for detachable engagement with the item to be retained, characterized in that it comprises means for detachable connection between said flexible cable and said supporting base.

### BRIEF DESCRIPTION OF THE DRAWINGS

Further characteristics and advantages of the invention will become better apparent from the description of some preferred but not exclusive embodiments of an anti-theft device according to the present invention, illustrated by way of non-limiting example in the accompanying drawings, wherein:

FIG. 1 is a diagram of a first example of embodiment of an anti-theft device according to the invention;

FIG. 2 is a diagram of a constructive variation of an anti-theft device according to the invention;

FIG. 3 is a perspective view of a practical example of embodiment of an anti-theft device according to the invention;

FIG. 4 is a view of the anti-theft device of FIG. 3 associated with a package.

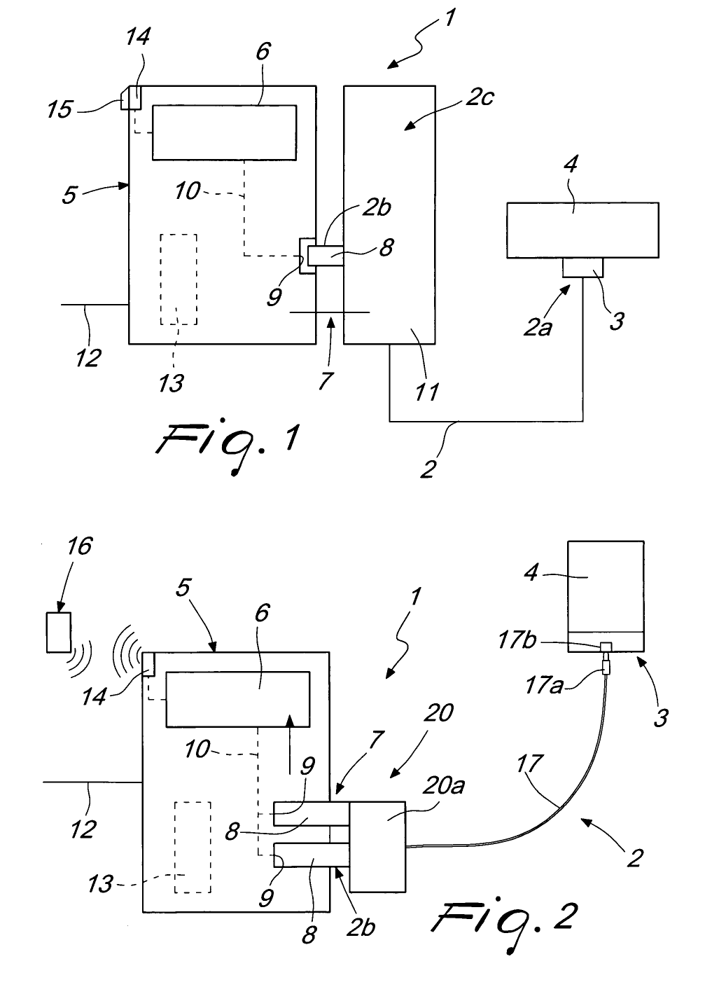

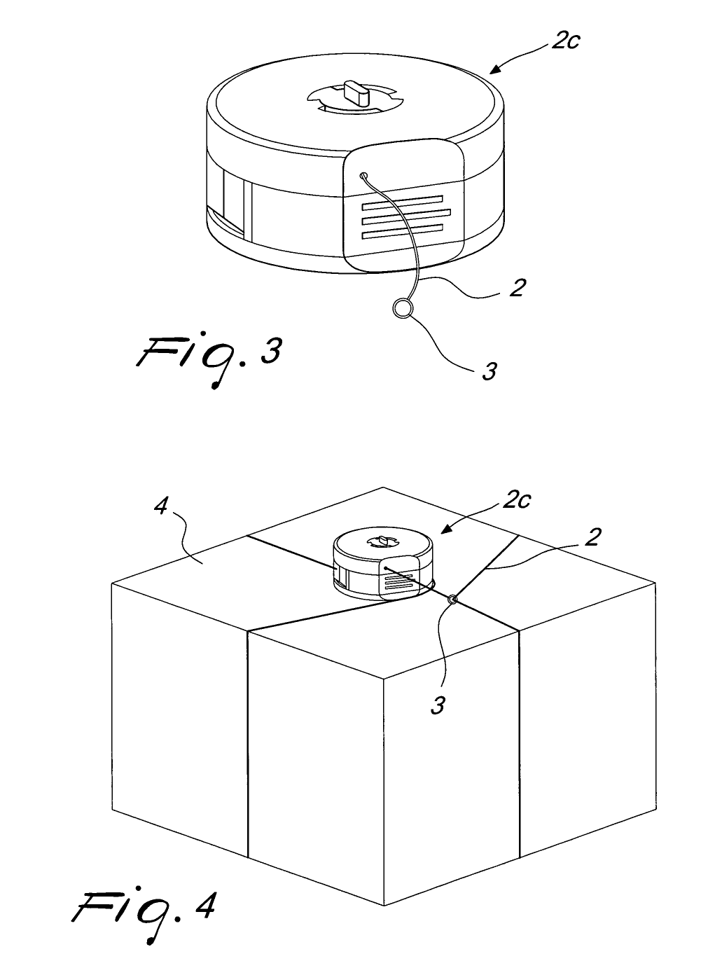

In the exemplary embodiments that follow, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

### DESCRIPTION OF THE PREFERRED EMBODIMENTS

With reference to the figures, an anti-theft device, generally designated by the reference numeral 1, comprises an electrically conducting flexible cable 2, which is connected, at one of its ends 2a, to means 3 for detachable engagement with an item 4 to be retained.

The flexible cable 2 is associated with detection means which are designed to check that the detachable engagement means 3 actually engage the item 4 to be retained.

Moreover, the anti-theft device 1 comprises a supporting base 5, which can be associated with a control unit 6 which is designed to act in response to the detection, by the detection means, of the engagement or disengagement of the detachable engagement means 3 with the item 4 to be retained.

According to the invention, the anti-theft device 1 comprises means 7 for detachable connection between the, or at least one, flexible cable 2 and the supporting base 5.

According to a first aspect, the flexible cable 2 comprises two conducting wires which are connected, at one end, to said detachable engagement means 3; in this case, the detector means can be adapted to act in response to the opening and/or closure of an electrical contact between the two conducting wires.

According to an important aspect of the invention, the flexible cable 2 has, at the end 2b opposite with respect to the end associated with the detachable engagement means 3, at least one connection terminal 8, which can be associated with a respective connector 9 which is defined on the supporting base 5 and is connected to the control unit 6 by way of per se known connection means 10.

Moreover, the detachable connection means can be constituted by one or more devices for locking one another the supporting base 5 and a body 2c for supporting the flexible cable 2.

This or these locking devices can be provided for example by bayonet-like or pressure-operated interconnection elements which, as mentioned, act between the supporting base 5 and the supporting body 2c.

Conveniently, the flexible cable 2 is associated with a spool 11, which is mounted so that it can rotate on the supporting body 2c, with respect to which it can be wound and unwound.

Advantageously in this case, there are means for elastic loading, not shown, which act on the spool 11 to ensure the tension and automatic rewinding of the flexible cable 2 onto the spool 11.

The supporting base 5 can be supplied with power by means of a cable 12 for electrical connection to the electrical mains and/or by means of a battery 13 which can be accommodated in the supporting base 5 and is preferably of the rechargeable type.

The control unit 6 can be activated by way of activation means 14, which can be operated by means of a manual switch 15 arranged on the outer portion of the supporting base 5 or, as shown in the example of FIG. 2, by means of a remote control 16.

There is nothing to prevent the activation of the anti-theft device 1 from being performed also by way of control means of the infrared, magnetic, transponder, radio frequency type or the like.

The detachable engagement means 3 comprise, for example, an element for closing the electrical contact between the two conducting wires which are arranged inside the flexible cable 2 and can be activated as a consequence of the coupling of the detachable engagement means 3 with the item 4 to be retained.

Still according to an important aspect of the invention, the flexible cable 2 comprises an electric power supply cable 17 of the type commonly provided to recharge batteries which can be associated with electronic devices such as cellular telephones, portable PCs, digital cameras and video cameras, and technological devices in general.

In this particular case, the detachable engagement means 3 comprise a power supply connector 17a, which is arranged at one end of the power supply cable 17 and can be coupled to a power supply socket 17b which is defined on the item 4 to be retained and is generally provided specifically in order to allow recharging of the batteries.

In this constructive variation, the detection means are adapted to act in response to the uncoupling of the power supply connector 17a from the power supply socket 17b.

In practice, if an ill-intentioned individual tried to uncouple the power supply connector 17a from the power supply socket 17b in order to steal the electronic device, the detection means would activate the control unit 6 and therefore the alarm associated therewith.

This solution allows operation during the display of the electronic device and at the same time provides an effective deterrent against theft attempts.

In this case, the detection means can be provided in different manners. In particular, it is possible to provide first of all a device for measuring the load to which the power supply cable 17 is subjected, which can be arranged along said power supply cable 17 or in the supporting base 5.

When the power supply connector 17a is disconnected from the power supply socket 17b, the electrical load to which the power supply cable 17 is subjected is eliminated, and the load measurement device, by detecting this situation, sends an activation signal to the control unit 6, which activates the alarm.

In this regard, it has been found that it can be convenient to provide the control unit 6 so that it can interrupt the flow current which passes through the power supply cable 17 for short time intervals (which advantageously can range from a fraction of a second to several seconds).

In practice, the interruption of the flow of current prevents the battery from recharging completely, thus ensuring that the electrical load can be controlled efficiently and continuously. In this manner, in fact, the load does not undergo the even substantial variations which may occur in some devices when the battery is completely charged.

Of course, shop visitors are unable to determine when the flow of current is interrupted and in any case, even if the power supply connector 17a were to be removed from the power supply socket 17b during this interval, after a few fractions of a second, when the control unit 6 reactivates the flow of current, the field measurement device would be able to detect a reduction in the load and therefore send an activation signal to the control unit, which would activate the alarm.

In this regard it has been found that by increasing significantly the frequency of the interruptions and consequently reducing the time that elapses between two consecutive recharging intervals, even if the battery is substantially charged, there is an absorption of current between each interruption period.

This allows the control unit to detect any disconnections of the power supply connector independently of the charging level of the battery connected to the item to be retained.

With reference to the same concept, it is convenient for the control unit 6 to be structured so as to measure and/or calibrate the voltage and/or current absorbed by the battery of the item 4 to be retained.

The control unit 6 therefore stores the value measured during this calibration step so as to have a comparison or threshold value during use.

If the control unit, during use of the anti-theft device 1, detects a voltage and/or current which is different from the stored comparison or threshold value, an alarm signal is generated.

As an alternative, it is possible to perform a first calibration while the item 4 to be retained is disconnected and then a second calibration while the item 4 to be retained is connected. Subsequently, at preset or random time periods, the control unit 6 performs an instantaneous measurement of the values of current and/or voltage, comparing them with the values related to the first and second calibrations. If the instantaneous values are substantially equal to those measured during the first calibration, the control unit 6 activates the alarm.

As an alternative, the detection means can be constituted by a brightness sensor which is provided for example at the power supply connector 17a and is designed to be arranged, when the power supply connector 17a is coupled to the power supply socket 17b, inside the power supply socket 17b and therefore in a region which is not exposed to the light.

If the power supply connector 17a is uncoupled from the power supply socket 17b, the brightness sensor detects an increase in light and therefore activates the control unit 6 to activate the alarm.

In another possible exemplary embodiment, the power supply cable 17 can be provided with two auxiliary conducting wires, which have ends which can be inserted within the power supply socket 17b and cooperate with an electrical interconnection bridge, which is adapted to keep the contact between the two auxiliary conducting wires closed when the power supply connector 17a is coupled to the power supply socket 17b.

With particular reference to such embodiment, the detachable connection means 7 are obtained from the terminal plug 20 of the power supply cable 17, which is provided, as usual, with the corresponding transformer 20a and can be inserted within a corresponding electrical socket provided on the supporting base 5.

The anti-theft device 1 as described above can be provided advantageously with detachable engagement means 3 which comprise a fastening element which, in the engaged condition, is adapted to lock at least one portion of the item to be retained.

However, it is possible to use different types of detachable engagement means, such as for example clamps, coupling rings, electrified straps or even adhesive tabs.

Detachable engagement means 3 constituted by a fastening element which is adapted to lock, with respect to the first end 2a, a portion of the flexible cable in order to define a retention rings 30 for the item 4 to be retained have been found to be particularly suitable for the purpose.

In this regard, there is nothing to prevent the use of a retention ring 30 which is designed to be crossed in order to “package”, as shown in FIG. 4, the item to be retained. This packaging prevents the opening of the package of the item and therefore the removal of such item from the box or of the microchip contained therein. In practice it is possible to obtain simply and effectively an anti-theft device 1 which prevents the opening of the box with which it is associated and simultaneously prevents removal of the item from the shop.

Operation of an anti-theft device according to the invention is evident from what has been described above.

All the characteristics of the invention described above as advantageous, convenient or the like may also be omitted or be replaced with equivalents.

The invention thus conceived is susceptible of numerous modifications and variations, all of which are within the scope of the appended claims.

In practice it has been found that the invention has achieved the intended aim and objects in all of its embodiments.

In particular, it is evident that the supporting base can be associated with any type of flexible cable and can operate with a plurality of detachable engagement means without allowing to compromise its operation.

This allows to retain any type of item and likewise to replace rapidly the parts which are defective and wear rapidly without the need for the intervention of a technician.

Likewise, it is possible to use displays which are already commercially available by simply acting on the supporting surfaces and/or on the display posts to provide the supporting bases with which it is then possible to associate, according to the requirements, the corresponding flexible cables with the respective removable engagement means.

Finally, in the case of flexible cables which comprise or are constituted by power supply cables, the items on display can be used and tested. If such items are constituted by mobile telephones, is possible, at will, to associate therewith a network SIM card capable of providing all information related to promotions, offers, tariff plans so as to allow customers to obtain information besides testing in practice the functions and graphical performance of the product on display.

From what has been described above, the described anti-theft device therefore allows to display technological material (cellular telephones, computers, et cetera) always on and powered, thus being able to ensure a service which is essential in order to assess the features and functionalities of the items.

Moreover, it is important to note that the spool can be rigidly coupled or simply rested on the display counter, since if an attempt to remove or tear the flexible cable occurs, the control unit detects this situation, activating the alarm.

Finally, it is evident that an anti-theft device according to the invention allows easy installation even if the interior of the shop is already equipped with different types of alarm devices.

In practice, the materials used, as well as the contingent shapes and dimensions, may be any according to requirements.

All the details may further be replaced with other technically equivalent elements.

The disclosures in Italian Patent Application No. VR2006A00168 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

What is claimed is:

1-17. (canceled)

18. An anti-theft device comprising an electrically conducting flexible cable which is connected, at one end, to means for detachable engagement with an item to be retained and is provided with means for detecting the engagement of said means for detachable engagement with the item to be retained, and a supporting base which can be associated with a control unit which is designed to act in response to the detection, by said detection means, of the engagement/disengagement of said means for detachable engagement with the item to be retained, further comprising means for detachable connection between said flexible cable and said supporting base.

19. The anti-theft device according to claim 18, wherein said flexible cable comprises two conducting wires which are connected, at one end, to said means for detachable engagement with an item to be retained, said detection means being adapted to act in response to the opening and/or closure of the electrical contact between said two conducting wires.

20. The anti-theft device according to claim 18, wherein said flexible cable has, at the opposite end with respect to the end associated with said detachable engagement means, a connection terminal which can be associated with a connector which is supported by said supporting base and is connected to said control unit.

21. The anti-theft device according to claim 18, wherein said cable is associated with a spool, which is mounted so that it can rotate on a support, and can be wound on and unwound from said spool, elastic loading means for said spool being provided in order to ensure the automatic rewinding and tensioning of said cable on said spool.

22. The anti-theft device according to claim 18, comprising means for activating said control unit.

23. The anti-theft device according to claim 18, comprising means for supplying power to said control unit.

24. The anti-theft device according to claim 23, wherein said means for supplying power to said control unit comprise the electrical supply mains or a power supply battery which is accommodated within said supporting base.

25. The anti-theft device according to claim 18, wherein said detachable engagement means comprise an element for closing said electrical contact which can be activated as a consequence of the coupling of said detachable connection means with said at least one item to be retained.

26. The anti-theft device according to claim 18, wherein said flexible cable comprises an electric power supply cable for said at least one item to be retained and said detachable engagement means comprise a power supply connector which can be coupled to a power supply socket which is provided on said item to be retained, said detection means being adapted to act in response to the uncoupling of said power supply connector with respect to said power supply socket.

27. The anti-theft device according to claim 26, wherein said detection means comprise a device for measuring the electrical load to which said power supply cable is subjected.

28. The anti-theft device according to claim 27, wherein said electrical load measurement device is adapted to detect the disconnection of said power supply connector from said power supply socket and to send an activation signal to said control unit to operate the alarm.

29. The anti-theft device according to claim 26, wherein said detection means comprise a brightness sensor which is provided substantially at said power supply connector and is designed to be arranged, when said power supply connector is coupled to said power supply socket, inside said power supply socket in a region which is not exposed to light, said brightness sensor being adapted, in case of disconnection of said power supply connector from said power supply socket, to detect an increase in lighting and therefore being adapted to activate said control unit in order to operate the alarm.

30. The anti-theft device according to claim 26, wherein said detection means comprise a pair of auxiliary conducting wires, which have ends which can be inserted within said power supply socket and cooperate with an electrical interconnection bridge, which is adapted to keep the contact between said two auxiliary conducting wires closed when said power supply connector is coupled to said power supply socket.

31. The anti-theft device according to claim 18, wherein said detachable connection means comprise a terminal plug of said power supply cable which can be inserted in a corresponding electrical socket provided in said supporting base.

32. The anti-theft device according to claim 26, wherein said control unit is adapted to act in response to the uncoupling of said power supply connector with respect to said power supply socket.

33. The anti-theft device according to claim 18, wherein said detachable engagement means comprise a fastening element which is adapted to lock in said engaged condition at least one portion of the item to be retained.

34. The anti-theft device according to claim 19, wherein said detachable engagement means comprise a fastening element which is adapted to lock, with respect to said one end, a portion of said cable in order to define a retaining ring for the item to be retained.
